(19) United States
(12) Patent Application Publication
(10) Pub. No.: US 2022/0109393 A1
(43) Pub. Date: Apr. 7, 2022

(54) MOTOR CONTROL DEVICE

(71) Applicant: MINEBEA MITSUMI Inc., Nagano (JP)

(72) Inventors: Masahiro KAWAGUCHI, Kitasaku-gun (JP); Tomohiro INOUE, Kitasaku-gun (JP)

(21) Appl. No.: 17/487,639

(22) Filed: Sep. 28, 2021

(30) Foreign Application Priority Data
Oct. 2, 2020 (JP) 2020-167772

(51) Int. Cl. H02P 29/40; H02P 29/10

(52) U.S. Cl. CPC H02P 29/40; H02P 29/10

(57) ABSTRACT

A motor control device includes a control unit configured to control power supplied to a motor, and a speed detection unit configured to detect a rotational speed of the motor. When the rotational speed of the motor detected by the speed detection unit does not reach a first threshold value, the control unit controls the power supplied to the motor to be a predetermined first power, and when the rotational speed of the motor reaches the first threshold value, the control unit controls the power to cause the power supplied to the motor to be lower than the first power.

### CROSS-REFERENCE TO RELATED APPLICATIONS

This application claims the benefit of priority to Japanese Patent Application Number 2020-167772 filed on Oct. 2, 2020. The entire contents of the above-identified application are hereby incorporated by reference.

### TECHNICAL FIELD

The present invention relates to a motor control device.

### BACKGROUND

For a motor control device configured to perform drive control of a motor, a technique for limiting the supply of power to a motor in accordance with a load state is known to protect the motor and the motor control device in an overload state (See JP 2012-531184 T).

### SUMMARY

Incidentally, there is known a motor control device for controlling power supplied to a motor constant (hereinafter referred to as “power control”).

Motor control devices configured to perform the power control in a conventional manner are required to be further improved to protect a motor or a drive system of the motor in consideration of the rotational speed of the motor rising higher than expected, for example, when a load of a motor becomes low.

An object of the present invention is to provide a motor control device capable of protecting a motor, taking the above-described problem as an example.

In order to achieve the object described above, a motor control device according to the present invention includes: a control unit configured to control power supplied to a motor; and a speed detection unit configured to detect a rotational speed of the motor. When the rotational speed of the motor detected by the speed detection unit does not reach a first threshold value, the control unit controls the power supplied to the motor to be a predetermined first power, and when the rotational speed of the motor reaches the first threshold value, the control unit controls the power to cause the power supplied to the motor to be lower than the first power.

In the motor control device according to an aspect of the present invention, in a state of supplying power lower than the first power to the motor, when the rotational speed of the motor detected by the speed detection unit reaches a second threshold value lower than the first threshold value, the control unit controls the power supplied to the motor to be the first power.

In the motor control device according to an aspect of the present invention, when the rotational speed of the motor detected by the speed detection unit reaches the first threshold value a predetermined number of times, the control unit controls the power to stop the motor.

The motor control device according to an aspect of the present invention includes a current detection unit configured to detect a current value supplied to the motor. When the rotational speed of the motor detected by the speed detection unit does not reach the first threshold value, the control unit controls the current value detected by the current detection unit to be a first current target value, and when the rotational speed of the motor reaches the first threshold value, the control unit controls current so that the current value detected by the current detection unit is a second current reference value lower than the first current target value.

In the motor control device according to an aspect of the present invention, when a predetermined time period elapses after the rotational speed of the motor reaches the first threshold value, the control unit controls the power to cause the power supplied to the motor to be a second power lower than the first power.

Accordingly, the motor control device according to the present invention can protect a motor.

### BRIEF DESCRIPTION OF DRAWINGS

FIG. 1 is a functional block diagram schematically illustrating a configuration of a motor device provided with a motor control device according to an embodiment of the present invention.

FIG. 2 is a graph showing an example of a relationship between a rotational speed of a motor controlled by the motor control device illustrated in FIG. 1, and an elapsed time.

FIG. 3 is a flowchart illustrating an example of processing performed by the motor control device illustrated in FIG. 1.

### DESCRIPTION OF EMBODIMENTS

A motor control device according to an embodiment of the present invention will be described below with reference to the drawings.

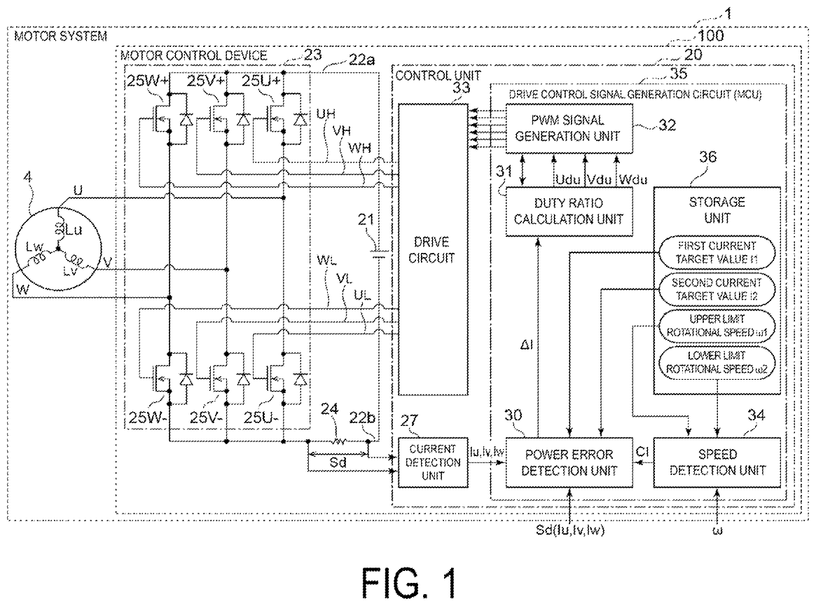

FIG. 1 is a functional block diagram schematically illustrating a configuration of a motor control device 100 according to the embodiment of the present invention.

As illustrated in FIG. 1, the motor control device 100 according to the present embodiment includes a control unit 20 configured to control power supplied to a motor 4, and a speed detection unit 34 configured to detect a rotational speed of the motor 4. When the rotational speed of the motor 4 detected by the speed detection unit 34 does not reach a first threshold value, the control unit 20 controls the power supplied to the motor 4 to be a predetermined first power, and when the rotational speed of the motor 4 has reached the first threshold value, the control unit 20 controls the power to cause the power supplied to the motor 4 to be lower than the first power. A configuration and an operation of the motor control device 100 will be described below in detail.

### Configuration of Motor Control Device

As illustrated in FIG. 1, the motor device 1 includes at least the motor 4, and the motor control device 100 configured to control a rotational operation of the motor 4. The motor device 1 is mounted at an apparatus such as a vacuum cleaner, for example. Note that the apparatus including the motor device 1 is not limited to this example.

The motor 4 includes a plurality of coils. The motor 4 includes, for example, a three-phase coil including a U phase coil Lu, a V phase coil Lv, and a W phase coil Lw. Specific examples of the motor 4 include a three-phase brushless motor, and the like. The U phase coil Lu, the V phase coil Lv, and the W phase coil Lw are connected to each other by star connection, for example.

The motor control device 100 converts a direct current into a three-phase alternating current to drive the motor 4, by performing on/off control of a plurality of three-phase bridge-connected switching elements, in accordance with an energization pattern including three-phase PWM signals.

Specifically, the motor control device 100 includes an inverter circuit 23 and the control unit 20.

The inverter circuit 23 is a circuit for converting direct current power supplied from a DC power source 21 to a three-phase alternating current through switching of the plurality of switching elements and sending a three-phase alternating drive current to the motor 4 to rotate a rotor of the motor 4. The inverter circuit 23 drives the motor 4 based on a plurality of the energization patterns generated by a drive control signal generation circuit 35 described below (more specifically, the three-phase PWM signals generated by a PWM signal generation unit 32 provided inside the drive control signal generation circuit 35).

The inverter circuit 23 includes a plurality of switching elements 25U+, 25V+, 25W+, 25U−, 25V−, and 25W−, the switching elements being three-phase bridge-connected. Each of the switching elements 25U+, 25V+, and 25W+ is a high-side switching element (an upper arm) connected to a positive electrode side of the DC power source 21 via a positive side bus 22a. Each of the switching elements 25U−, 25V−, and 25W− is a low side switching element (a lower arm) connected to a negative electrode side (specifically, a ground side) of the DC power source 21. Each of the plurality of switching elements 25U+, 25V+, 25W+, 25U−, 25V−, and 25W− is turned on or off in accordance with a corresponding drive signal among a plurality of the drive signals supplied from a drive circuit 33 based on the PWM signals included in the above-described energization patterns. Hereinafter, when the plurality of switching elements 25U+, 25V+, 25W+, 25U−, 25V−, and 25W− are not particularly distinguished from each other, they may be simply referred to as the switching elements.

A connection point between the switching element 25U+ and the switching element 25U− is connected to one end of the U phase coil Lu of the motor 4. A connection point of the switching element 25V+ and the switching element 25V− is connected to one end of the V phase coil Lv of the motor 4. A connection point of the switching element 25W+ and the switching element 25W− is connected to one end of the W phase coil Lw of the motor 4. The other ends of each of the U phase coil Lu, the V phase coil Lv, and the W phase coil Lw are connected to each other.

Specific examples of the switching element include an N-channel type metal oxide semiconductor field effect transistor (MOSFET), an insulated gate bipolar transistor (IGBT), and the like. However, the switching element is not limited to these examples.

A current detection unit 24 generates a detection signal Sd corresponding to a current value of a current flowing at a direct current side of the inverter circuit 23. The current detection unit 24 illustrated in FIG. 1 generates the detection signal Sd corresponding to the current value of the current flowing at a negative side bus 22b. The current detection unit 24 is, for example, a current detection element disposed at the negative side bus 22b, and more specifically, is a resistor (shunt resistor) inserted into the negative side bus 22b. The current detection element such as the shunt resistor generates a voltage signal corresponding to a current value of a current flowing in the current detection element itself as the detection signal Sd. Note that as long as the current detection unit 24 outputs the detection signal Sd corresponding to the current value of the current flowing through the negative side bus 22b, the current detection unit 24 may be a sensor such as a current transformer (CT).

The control unit 20 generates a plurality of the PWM signals corresponding to each phase of the motor 4. The control unit 20 includes, for example, a processor such as a central processing unit (CPU), various storage devices such as a random access memory (RAM) and a read only memory (ROM), a counter (timer), and a program processing device (a microcontroller, for example) including peripheral circuits, such as an A/D conversion circuit, a D/A conversion circuit, and an input/output I/F (Interface), connected to each other via a bus. In the present embodiment, the control unit 20 is packaged as an integrated circuit (IC), but the control unit 20 is not limited to this example.

The control unit 20 generates the PWM signals so that the motor 4 operates appropriately, for example, based on a current rotational speed ωC of the motor 4 input from a host device (not illustrated), and on a phase current of each of the phases of the motor 4 based on the detection signal Sd of the current detection unit 24.

Next, a specific configuration for generating the PWM signal of each of the phases and a specific configuration for detecting the phase current at the motor control device 100 will be described in detail.

As illustrated in FIG. 1, the control unit 20 includes a current detection unit 27, the drive circuit 33, and the drive control signal generation circuit 35 as functional blocks for generating the PWM signal for each of the phases.

The current detection unit 27 detects phase currents Iu, Iv, and Iw of each of phases U, V, and W flowing through the motor 4 by acquiring the detection signals Sd based on the plurality of energization patterns (more specifically, the three-phase PWM signals) generated by the drive control signal generation circuit 35. Measured values of the phase currents Iu, Iv, and Iw, of each of the phases, measured by the current detection unit 27, are supplied to the drive control signal generation circuit 35.

The drive control signal generation circuit 35 determines a difference ΔI between current values, based on the measured values of the phase currents Iu, Iv, and Iw of the motor 4 measured by the current detection unit 27, and the current rotational speed ωC of the motor. Further, the drive control signal generation circuit 35 calculates a duty ratio for driving the motor 4 based on the difference ΔI between the determined current values and the current rotational speed ωC of the motor, and generates a signal specifying a pattern for energizing the inverter circuit 23 (an energization pattern of the inverter circuit 23).

Here, the energization pattern of the inverter circuit 23 may also be referred to as a pattern for energizing the motor 4 (an energization pattern of the motor 4). The signal specifying the energization pattern of the inverter circuit 23 includes the three-phase PWM signals for energizing the inverter circuit 23 to rotate the motor 4.

In the present embodiment, the drive control signal generation circuit 35 generates the energization pattern of the inverter circuit 23 by vector control. Note that a method for generating the energization pattern of the inverter circuit 23 is not limited to the vector control, and a method for determining a phase voltage of each of the phases using vf control, or the like may be used.

Specifically, the drive control signal generation circuit 35 includes a power error detection unit 30, a duty ratio calculation unit 31, a PWM signal generation unit 32, a speed detection unit 34, and a storage unit 36.

The speed detection unit 34 detects the current rotational speed ωC of the motor 4. The speed detection unit 34 calculates a torque current Iq and an excitation current Id by vector control operation using a rotor position θ based on the measured values of the phase currents Iu, Iv, and Iw measured by the current detection unit 27, and, based on the torque current Iq and the excitation current Id, calculates a measured value or an estimated value of the rotational speed of the motor 4. Note that, at the motor control device 100, a method for detecting the current rotational speed ωC of the motor 4 by the speed detection unit 34 is not limited to the above-described example. At the motor control device 100, the current rotational speed ωC of the motor 4 may be, for example, the rotational speed of the rotor measured by a sensor for detecting the rotational speed of the rotor, such as a Hall effect sensor, provided at the motor 4.

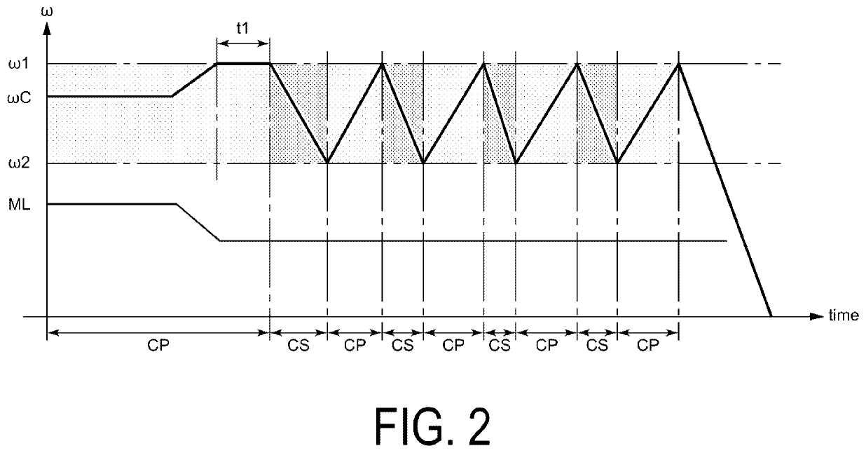

FIG. 2 is a graph showing an example of a relationship between the current rotational speed ωC of the motor 4 controlled by the motor control device 100, and an elapsed time.

The speed detection unit 34 performs the following processing using the calculated measured value or estimated value of the rotational speed of the motor 4 as the detected current rotational speed ωC of the motor 4.

The speed detection unit 34 determines whether the detected current rotational speed ωC of the motor 4 has reached the first threshold value, that is, an upper limit value of a rotational speed ω of the motor 4 stored at the storage unit 36 (hereinafter referred to as an “upper limit rotational speed ω1”). When the current rotational speed ωC of the motor 4 has reached the upper limit rotational speed ω1, the speed detection unit 34 outputs, to the power error detection unit 30, control switching instruction information CI for switching the control, by the power error detection unit 30, of the power supplied to the motor 4 from a power control CP configured to control the power supplied to the motor 4 to be constant to a speed control CS configured to control the rotational speed of the motor 4 to be constant.

Further, when the power control by the power error detection unit 30 is the speed control CS, the speed detection unit 34 determines whether the current rotational speed ωC of the motor 4 has reached a second threshold value, that is, a lower limit value of the rotational speed ω of the motor 4 stored at the storage unit 36 (hereinafter referred to as a “lower limit rotational speed ω2”). When the current rotational speed ωC of the motor 4 has reached the lower limit rotational speed ω2, the speed detection unit 34 outputs, to the power error detection unit 30, the control switching instruction information CI for switching the control, by the power error detection unit 30, of the power supplied to the motor 4 from the speed control CS configured to control the rotational speed of the motor 4 to be constant, to the power control CP configured to control the power supplied to the motor 4 to be constant.

FIG. 2 is a graph showing an example of a relationship between the rotational speed ω of the motor 4 controlled by the motor control device 100, the elapsed time, and a load ML of the motor 4.

As illustrated in FIG. 2, when the current rotational speed ωC does not reach the upper limit rotational speed ω1, specifically, when the rotational speed ω of the motor 4 required by the motor device 1 (hereinafter referred to as a “target rotational speed ωa”) is being maintained, the power error detection unit 30 supplies the power to be supplied to the motor 4 under the power control CP. In other words, as the power control CP, the power error detection unit 30 controls the current values (the measured values of the phase currents Iu, Iv, and Iw) detected by the current detection unit 27, so that the power supplied to the motor 4 becomes a predetermined power (a first power) required to achieve the target rotational speed ωa of the motor 4. Specifically, in order to achieve the target rotational speed ωa, the power error detection unit 30 calculates the difference ΔI between the current values for controlling the duty ratio calculation unit 31 so that the current to be supplied to the motor 4 is a predetermined first current target value I1 stored at the storage unit 36, and outputs this difference ΔI between the current values to the duty ratio calculation unit 31.

Even though the difference ΔI between the current values has been calculated so as to achieve the predetermined first current target value I1 and has been output to the duty ratio calculation unit 31, when the current rotational speed ωC exceeds the target rotational speed ωa and has reached the upper limit rotational speed ω1, the power error detection unit 30 changes the power control CP to the speed control CS and supplies the power supplied to the motor 4 under the power control CP, in accordance with the control switching instruction information CI from the speed detection unit 34. In other words, as the speed control CS, the power error detection unit 30 controls the current values (the measured values of the phase currents Iu, Iv, and Iw) detected by the current detection unit 27, so that the power supplied to the motor 4 becomes a predetermined power (a second power) required to achieve the lower limit rotational speed ω2 of the motor 4. Specifically, the power error detection unit 30 calculates the difference ΔI between the current values for controlling the duty ratio calculation unit 31 so that the current supplied to the motor 4 is a predetermined second current reference value stored at the storage unit 36, and outputs this difference ΔI between the current values to the duty ratio calculation unit 31.

Here, when the current rotational speed ωC has reached the upper limit rotational speed ω1, and the power error detection unit 30 changes the control of the power supplied to the motor 4 from the power control CP to the speed control CS, the power error detection unit 30 may make the change to the speed control CS after a predetermined time period t1, for example, after approximately one second or two seconds has elapsed after receiving the control switching instruction information CI from the speed detection unit 34.

In a state of supplying power lower than the first power to the motor 4 (in a state of performing the speed control CS), when the current rotational speed ωC of the motor 4 detected by the speed detection unit 34 has reached the lower limit rotational speed ω2 lower than the upper limit rotational speed ω1, the power error detection unit 30 receives the control switching instruction information CI output from the speed detection unit 34. In accordance with the received control switching instruction information CI, the power error detection unit 30 switches the control of the power supplied to the motor 4 back to the power control CP once again, and controls the power supplied to the motor 4 to be the first power.

When the current rotational speed ωC of the motor 4 detected by the speed detection unit 34 has reached the upper limit rotational speed ω1 a predetermined number of times, for example, five times after the motor device 1 is activated, the power error detection unit 30 determines that the load ML has increased due to some sort of problem relating to the motor 4, and stops the output to the duty ratio calculation unit 31 to stop the motor 4. Note that when the number of times the current rotational speed ωC has reached the upper limit rotational speed ω1 is less than the predetermined number of times, the power error detection unit 30 determines that the load ML of the motor 4 has returned to normal, and continues the drive control of the motor 4.

The duty ratio calculation unit 31 is a functional unit for generating the PWM signal as the signal specifying the energization pattern of the inverter circuit 23. Based on a detection result, by the power error detection unit 30, of the difference ΔI between the current values, the duty ratio calculation unit 31 calculates duty ratios (set values of duty ratios for each of the phases) Udu, Vdu, and Wdu for generating the three-phase PWM signals.

Based on the duty ratios Udu, Vdu, and Wdu for each of the phases set by the duty ratio calculation unit 39, the PWM signal generation unit 32 generates three-phase PWM signals U, V, and W as energization pattern signals. The PWM signal generation unit 32 outputs each of the generated PWM signals U, V, and W to the drive circuit 33.

Based on the energization patterns including the supplied PWM signals, the drive circuit 33 outputs the drive signals for causing the six switching elements 25U+, 25V+, 25W+, 25U−, 25V−, and 25W− included in the inverter circuit 23 to be switched. As a result, the three-phase alternating drive current is supplied to the motor 4 to rotate the rotor of the motor 4.

Note that the current detection unit 27 and the drive control signal generation circuit 35 are realized by a processor (a CPU, for example) performing various arithmetic operations in accordance with a program stored at a storage device (not illustrated) in a readable manner. For example, each of these functions is realized by hardware and software cooperating with each other at a microcomputer including a CPU.

### Operation of Motor Control Device

Next, an operation of the motor control device 100 having the above-described configuration will be described using a flowchart.

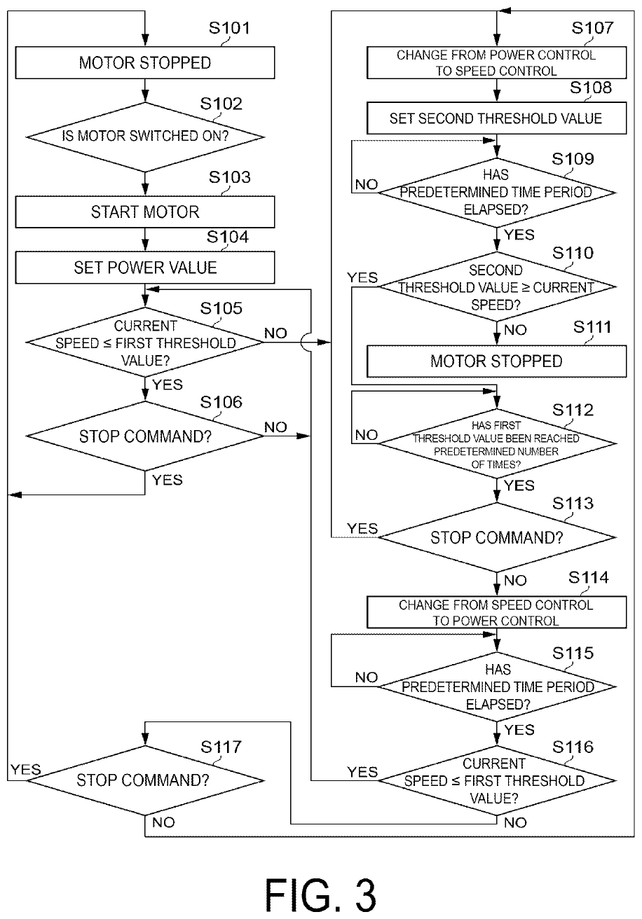

FIG. 3 is a flowchart illustrating an example of processing performed by the motor control device 100.

As illustrated in FIG. 3, in a state of the motor 4 being stopped (step S101), the drive control signal generation circuit 35 of the motor control device 100 determines whether the power of the motor device 1 has been switched on (activated) (step S102). When the power of the motor device 1 is not switched on (step S102: NO), the drive control signal generation circuit 35 returns to the processing of step S101.

When the power of the motor device 1 has been switched on (step S102: YES), the drive control signal generation circuit 35 starts the operation of the motor 4 (step S103). In order to achieve the target rotational speed ωa, the first current target value I1 corresponding to a power value of the predetermined first power is read from the storage unit 36 and set at the power error detection unit 30 (step S104). The power error detection unit 30 calculates the difference ΔI between the current values for controlling the duty ratio calculation unit 31 so that the current supplied to the motor 4 is the first current target value I1, and outputs this difference ΔI between the current values to the duty ratio calculation unit 31.

The speed detection unit 34 determines whether the detected current rotational speed ωC of the motor 4 has not reached the first threshold value, that is, the upper limit rotational speed ω1 (step S105).

When the speed detection unit 34 determines that the detected current rotational speed ωC of the motor 4 has not reached the first threshold value, that is, the upper limit rotational speed ω1 (step S105: YES), the power error detection unit 30 determines whether a command (stop command) for stopping the operation of the motor device 1 has been received from the host device (step S106). When the stop command has been received (step S106: YES), the power error detection unit 30 returns to the processing of step S101 to stop the operation of the motor device 1. When the stop command has not been received (step S106: NO), the processing returns to step S105.

When the detected current rotational speed ωC of the motor 4 has reached the first threshold value, that is, the upper limit rotational speed ω1 (step S105: NO), the speed detection unit 34 outputs, to the power error detection unit 30, the control switching instruction information CI for switching the control, by the power error detection unit 30, of the power supplied to the motor 4 from the power control CP to the speed control CS. In accordance with the control switching instruction information CI from the speed detection unit 34, the power error detection unit 30 changes the power control CP to the speed control CS, and supplies the power supplied to the motor 4 under the speed control CS (step S107).

A second current target value I2 corresponding to a power value of the predetermined second power required for the current rotational speed ωC of the motor 4 to achieve the lower limit rotational speed ω2 is read from the storage unit 36 and set at the power error detection unit 30 (step S108).

When changing the control of the power supplied to the motor 4 from the power control CP to the speed control CS, the power error detection unit 30 determines whether the predetermined time period t1, for example, one second has elapsed after receiving the control switching instruction information CI from the speed detection unit 34 (step S109). The power error detection unit 30 repeats the processing of step S109 until the predetermined time period t1 elapses (step S109: NO).

After the predetermined time period t1 has elapsed (step S109: YES), in order to control the motor 4 under the speed control CS, the power error detection unit 30 calculates the difference ΔI between the current values for controlling the duty ratio calculation unit 31 so that the current supplied to the motor 4 is the second current target value I2, and outputs the calculated difference ΔI to the duty ratio calculation unit 31. The speed detection unit 34 determines whether the current rotational speed ωC of the motor 4 has reached the lower limit rotational speed ω2 (step S110).

When the current rotational speed ωC of the motor 4 has not reached the lower limit rotational speed ω2 (step S110: NO), the power error detection unit 30 determines that the increase in the load ML has occurred due to some sort of problem relating to the motor 4, and stops the output to the duty ratio calculation unit 31 to stop the motor 4 (step S111).

When the current rotational speed ωC of the motor 4 has reached the lower limit rotational speed ω2 (step S110: YES), the power error detection unit 30 determines whether the current rotational speed ωC of the motor 4 detected by the speed detection unit 34 has reached the upper limit rotational speed ω1 the predetermined number of times, for example, five times after the motor device 1 is activated (step S112). When the current rotational speed ωC of the motor 4 has reached the upper limit rotational speed ω1 the predetermined number of times (step S112: YES), the power error detection unit 30 determines that the increase in the load ML has occurred due to some sort of problem relating to the motor 4, and returns to the processing of step S101 to stop the output to the duty ratio calculation unit 31 to stop the motor 4.

On the other hand, when the current rotational speed ωC of the motor 4 has not reached the upper limit rotational speed ω1 the predetermined number of times (step S112: NO), the power error detection unit 30 determines whether the command (stop command) for stopping the operation of the motor device 1 has been received from the host device (step S113). When the stop command has been received (step S113: YES), the power error detection unit 30 returns to the processing of step S101 to stop the operation of the motor device 1.

When the stop command has not been received (step S113: NO), and if the current rotational speed ωC of the motor 4 detected by the speed detection unit 34 has reached the lower limit rotational speed ω2, the power error detection unit 30 receives the control switching instruction information CI output from the speed detection unit 34. In accordance with the received control switching instruction information CI, the power error detection unit 30 switches the control of the power supplied to the motor 4 back to the power control CP once again, and controls the power supplied to the motor 4 to be the first power (step S114).

When changing the control of the power supplied to the motor 4 from the power control CP to the speed control CS, the power error detection unit 30 determines whether the predetermined time period t1, for example, one second, has elapsed after receiving the control switching instruction information CI from the speed detection unit 34 (step S115). The power error detection unit 30 repeats the processing of step S115 until the predetermined time period t1 elapses (step S115: NO).

When the predetermined time period t1 has elapsed (step S115: YES), the speed detection unit 34 determines whether the detected current rotational speed ωC of the motor 4 has not reached the first threshold, that is, the upper limit rotational speed ω1 (step S116). When the speed detection unit 34 determines that the detected current rotational speed ωC of the motor 4 has not reached the first threshold, that is, the upper limit rotational speed ω1 (step S116: YES), the speed detection unit 34 returns to the processing of step S105.

When the speed detection unit 34 determines that the detected current rotational speed ωC of the motor 4 has reached the first threshold value, that is, the upper limit rotational speed ω1 (step S116: NO), the power error detection unit 30 determines whether the command (stop command) for stopping the operation of the motor device 1 has been received from the host device (step S117). When the stop command has been received (step S117: YES), the power error detection unit 30 returns to the processing of step S101 to stop the operation of the motor device 1. When the stop command has not been received (step S117: NO), the processing returns to step S107.

The motor control device 100 configured as described above can prevent the current rotational speed ωC from rising above the predetermined upper limit rotational speed ω1 by shifting the drive control of the motor 4 from the speed control to the power control, even when the load ML of the motor 4 has increased to a level higher than normal.

After shifting the drive control of the motor 4 to the power control, when the current rotational speed ωC of the motor 4 has reached the predetermined lower limit rotational speed ω2, the motor control device 100 can improve a load state of the motor 4 while maintaining a drive state of the motor 4 by shifting the drive control of the motor 4 back to the speed control once again and repeatedly determining whether the current rotational speed ωC of the motor 4 has reached the upper limit rotational speed ω1, a predetermined number of times. Further, when the current rotational speed ωC of the motor 4 has reached the upper limit rotational speed ω1 even after repeating the above-described shifts between the speed control and the power control a predetermined number of times, the motor control device 100 can protect the motor 4 by stopping the operation of the motor 4.

Thus, according to the motor control device 100, the motor 4 can be protected.

In addition, the motor control device according to the present invention may be modified as appropriate by those skilled in the art in accordance with known knowledge. Such modifications are of course included in the scope of the present invention as long as these modifications still include the configuration in the present invention.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1. A motor control device, comprising:
a control unit configured to control power supplied to a motor; and
a speed detection unit configured to detect a rotational speed of the motor, wherein
when the rotational speed of the motor detected by the speed detection unit does not reach a first threshold value, the control unit controls the power supplied to the motor to be a predetermined first power, and
when the rotational speed of the motor reaches the first threshold value, the control unit controls the power to cause the power supplied to the motor to be lower than the first power.

2. The motor control device according to claim 1, wherein
in a state of supplying power lower than the first power to the motor, when the rotational speed of the motor detected by the speed detection unit reaches a second threshold value lower than the first threshold value, the control unit controls the power supplied to the motor to be the first power.

3. The motor control device according to claim 1, wherein
when the rotational speed of the motor detected by the speed detection unit reaches the first threshold value a predetermined number of times, the control unit controls the power to stop the motor.

4. The motor control device according to claim 1, comprising:
a current detection unit configured to detect a current value supplied to the motor, wherein
when the rotational speed of the motor detected by the speed detection unit does not reach the first threshold value, the control unit controls the current value detected by the current detection unit to be a first current target value, and
when the rotational speed of the motor reaches the first threshold value, the control unit controls current so that the current value detected by the current detection unit is a second current reference value lower than the first current target value.

5. The motor control device according to claim 1, wherein
when a predetermined time period elapses after the rotational speed of the motor reaches the first threshold value, the control unit controls the power to cause the power supplied to the motor to be a second power lower than the first power.
